(19) United States
(12) Patent Application Publication
(10) Pub. No.: US 2010/0086514 A1
(43) Pub. Date: Apr. 8, 2010

(54) Contact Lens Care Solutions with a Low Molecular Weight Oligomer

(76) Inventors: X. Michael Liu, Pittsford, NY (US); David J. Heiler, Avon, NY (US)

Correspondence Address: Bausch & Lomb Incorporated, One Bausch & Lomb Place, Rochester, NY, 14604-2701, US

(21) Appl. No.: 12/571,465

(22) Filed: Oct. 1, 2009

Related U.S. Application Data
(60) Provisional application No. 61/102,972, filed on Oct. 6, 2008.

(51) Int. Cl. A01N 33/12; A01N 25/00; A01P 1/00; A01N 33/02

(52) U.S. Cl. 424/78.08; 514/772.3; 514/772.5; 514/772.4

(57) ABSTRACT

A contact lens care solution comprising: a cationic antimicrobial component having an average molecular weight (M_{NA}), and a cationic oligomer or nitrogen/amine oligomer having a number average molecular weight (M_{NO}) from 500 daltons to 15,000 daltons. The lens care solutions are used to clean and disinfect contact lenses, and in particular, soft, silicone hydrogel contact lenses.

This U.S. patent application claims the benefit under 35 U.S.C. 119(e) of U.S. provisional application No. 61/102,972 filed Oct. 10, 2008.

The present invention relates to contact lens care solutions with a cationic antimicrobial component, and a low molecular weight cationic or nitrogen/amine-based oligomer. The invention is also directed to the use of the contact lens care solutions to clean and disinfect contact lenses.

### BACKGROUND OF THE INVENTION

During normal use, contact lenses become soiled or contaminated with a wide variety of compounds that can degrade lens performance. For example, a contact lens will become soiled with biological materials such as proteins or lipids that are present in the tear fluid and which adhere to the lens surface. Also, by handling of the contact lens, sebum (skin oil) or cosmetics or other materials can soil the contact lens. These biological and external contaminants can affect visual acuity and patient comfort. Accordingly, it is important to remove any debris from the lens surface for continued comfortable use with a lens care solution that contains one or more cleaning components.

Ophthalmic compositions formulated as a lens care solution must also contain one or more antimicrobial components. Presently, the two most popular antimicrobial components are poly(hexamethylene biguanide), at times referred to as PHMB (or PAPB), and polyquaternium-1.

The PHMB-based lens care solutions represent a significant improvement in patient comfort and antimicrobial effectiveness compared to most other antimicrobial components. However, as with any antimicrobial component there remains a tradeoff between the concentration of the antimicrobial component in the solution and the comfort experienced by the patient. Due to its wide commercial acceptance, extensive efforts have been directed to improve the antimicrobial efficacy or the comfort level to the patient by chemically modifying PHMB.

Cellulose-based and polysaccharide-based polymers have been used in contact lens care solutions to minimize absorption of cationic antimicrobial components such as PHMB into the lenses. These cellulose-based and polysaccharide-based polymers tended to have an average molecular weight greater than 200,000 daltons. For example, the average molecular weight of Polymer JR 30M, which is present in Baush&Lombs MoistureLoc® MPS, was greater than 1,000,000 daltons. Although high molecular weight cellulose-based and polysaccharide-based polymers can provide certain benefits such as long lasting comfort, they have relatively poor mobility and do not compete with the much smaller, polymeric antimicrobial components for the pores of contact lens materials. As a result, the high molecular weight polymers are likely to have little or no effect on the uptake of cationic antimicrobial components on or into the lens.

There remains an interest and need for an improved lens care solution that offers an enhanced comfort profile to the patient without sacrificing antimicrobial efficacy. Accordingly, Applicants sought out and developed solutions that minimize the absorption of cationic antimicrobial components on or within the lens material.

### SUMMARY OF THE INVENTION

This invention recognizes the benefit of using low molecular weight, (i.e., a number average molecular weight in the range of 500 daltons to 15,000 daltons) of cationic oligomer or nitrogen/amine oligomer as agents to minimize the uptake of cationic antimicrobial components by contact lens materials. The low molecular weight cationic oligomer or nitrogen/amine oligomer is believed to compete with the cationic antimicrobial component for the pores of the contact lens materials. The result is a contact lens care solution with improved biocidal efficacy over time and improved comfort to the patient.

Accordingly, this invention is directed to a contact lens care solution comprising an effective amount of cationic oligomer or nitrogen/amine oligomer with a number average molecular weight of 500 daltons to 15,000 daltons. The number average molecular weight of the cationic oligomer or nitrogen/amine oligomer should be similar to those of the cationic antimicrobial component. In fact, the ratio of the average number molecular weight of the oligomer (M_{NO}) to the average number molecular weight of the antimicrobial component (M_{NA}) is from 5:1 to 1:5.

### DETAILED DESCRIPTION OF THE INVENTION

Contact lenses, e.g., conventional hydrogel and silicone hydrogel contact lenses, are made of porous polymeric materials. The pores on the surface and within the contact lens materials are available as sites for absorption of cationic antimicrobial components. Consequently, the absorption of these components leads to a reduction in the effective concentration of the antimicrobial component in the solution over time. It is for this reason, why patients should always completely discard the lens care solution from the lens case following a disinfection cycle. The practice of adding small amounts of fresh lens care solution to used (yesterdays) solution, which is known in the art as “topping off”, should not be practiced and is highly discouraged by all lens care solution manufacturers.

The absorption of antimicrobial components on and within the polymeric lens materials during a daily disinfection regimen can cause irritation and discomfort to the patient. Following placement on the eye, the absorbed antimicrobial components are released from the lens or displaced by the tear fluid resulting in a localized concentration of antimicrobial components in contact with ocular tissue. If one can minimize the amount of uptake of antimicrobial component into a lens material, then theoretically, one will also reduce the amount of antimicrobial component that comes in contact with ocular tissues, and thus, reduce ocular irritation or patient discomfort. Moreover, by minimizing the uptake of antimicrobial component into the lens one could theoretically, reduce the amount of antimicrobial components in the lens care solution because more is now available in solution for disinfection.

Applicants and others at Bausch & Lomb have developed and tested numerous contact lens care solutions. Almost all such solutions, however, fail to satisfy each and every one of the functional characteristics required of a commercial lens care solution. First, the solutions must possess the cleaning ability to remove denatured tear proteins and tear lipids as well as other external contaminants. Second, the solutions must possess significant disinfecting ability against a number of different bacteria and fungal strains. Third, the solutions must remain comfortable to the contact lens patient with minimal stinging as well as provide a platform to provide additional comfort or protection to the ocular surface. Fourth, the solutions must not cause significant shrinkage or swelling of the many different contact lens materials, which in turn can lead to loss in visual acuity and unwanted or pronounced lens movement. In fact, the addition of just one component can directly or indirectly alter the chemical dynamics of a multi-component, e.g., six to eight component, lens care solution, and consequently affect the mechanical properties of a lens material. Moreover, there are about ten different types of lens materials to test, and each lens material must satisfy set specification limits for shrinkage or swelling.

In addition to all of the above characteristics, the solution must also pass a stringent test protocol that is referred by those in the art as “regimen” testing. An ophthalmic composition selectively formulated to clean and disinfect soft, silicone, hydrogel contact lenses must satisfy “regimen” testing for that formulation to obtain label approval from the Food and Drug Administration (FDA) as a no rub, contact lens cleaning and disinfecting solution. Many lens care formulations during development fail to pass the regimen test with each and every silicone hydrogel contact lens in the U.S. market. In fact, some commercialized solutions presently marketed as a “no-rub” for silicone hydrogel lenses fail this FDA test with respect to certain microorganisms.

Applicant's developmental program and their investigations of numerous ophthalmic formulations have led to an important insight. One, cationic oligomers or nitrogen/amine oligomers with a number average molecular weight value from 500 daltons to 15,000 daltons can be used to minimize the uptake of a cationic antimicrobial component such as PHMB or polyquaternium-1 by the contact lens. It is believed that the cationic oligomer or nitrogen/amine oligomer effectively competes with the cationic antimicrobial components to occupy the pores of polymeric lens materials, i.e., the pores of conventional and silicone hydrogels. As a result, the concentration of non-absorbed antimicrobial component in solution is higher, which results in a solution with greater biocidal efficacy. Moreover, the decrease in the amount of cationic antimicrobial component absorbed onto the lens material is expected to increase patient comfort or reduce ocular irritation.

Accordingly, this invention is directed to contact lens care solutions comprising an effective amount of cationic oligomer or nitrogen/amine oligomer having a number average molecular weight of from 500 daltons to 15,000 daltons. The concentration of the oligomer in the solution should be 10 to 1,000 times the concentration of that of the cationic antimicrobial component. Ideally, the number average molecular weights of the oligomer should be similar to that of the antimicrobial component. Accordingly, a ratio of the average number molecular weight of the oligomer (M_{NO}) to the average number molecular weight of the antimicrobial component (M_{NA}) is from 5:1 to 1:5, or from 3:1 to 1:3.

### The Use of the Low Molecular Weight Oligomer in Multi-Purpose Lens Care Solutions

Any low molecular weight, cationic oligomer or nitrogen/amine oligomer can be used to prepare the described lens care solutions. It is also to be understood to one of ordinary skill that one could also use a low molecular weight copolymer comprising monomeric units with cationic or nitrogen/amine groups as part of the copolymer to achieve a similar affect compared to the homologous oligomer. As stated, the oligomer will have a number average molecular weight from 500 daltons to 15,000 daltons, and in many instances, the oligomer will have a number average molecular weight from 1000 daltons to 6,000 daltons.

The low molecular weight, cationic oligomer or nitrogen/amine oligomer is present in the lens care solution from 0.0001 wt. % to 3 wt %, from 0.001 wt. % to 0.5 wt. % or from 0.01 wt. % to 0.1 wt. %. As expected, the amount of oligomer added to the solution will depend on a number of different factors such as the type of cationic antimicrobial component(s) present in the solution and their respective concentrations. In most cases, the concentration of the oligomer in the solution will be at least ten (10) times the concentration of the cationic antimicrobial component(s). Typically, the described lens care solutions will have a 10 times to 1000 times more oligomer by weight than the cationic antimicrobial component(s).

Certain embodiments of low molecular weight, cationic oligomer or nitrogen/amine oligomer is selected from the group consisting of polyvinylpridine, polyvinylpyrrolidone or polythyleneimine, or as noted above, as a copolymer of each thereof. For example, a copolymer with a number average molecular weight from 500 daltons to 15,000 daltons prepared from vinylpyrrolidone and vinylalcohol or 2-hydroxyethyl methacrylate can be used

In particular, Applicants have shown that the presence of low molecular weight, cationic oligomer or nitrogen/amine oligomer in lens care solutions that also include PHMB or α-[4-tris(2-hydroxyethyl)ammonium chloride-2-butenyl]poly[1-dimethylammonium chloride-2-butenyl]-ω-tris(2-hydroxyethyl)ammonium chloride (available as Polyquaternium-1® from Stepan Corporation) can minimize the uptake of these two cationic antimicrobial components by contact lens materials, particularly silicone hydrogel lens materials and those known in the art as Group IV lenses. Of course, it is to be understood in the art that the low molecular weight, cationic oligomer or nitrogen/amine oligomer can be used with any cationic antimicrobial component as well as PHMB or polyquaternium-1, e.g., polyquaternium-42 or 1,1′-hexamethylene-bis[5-(2-ethylhexyl)biguanide], which is referred to in the art as “alexidine”.

PHMB is present in the lens care solutions from 0.1 ppm to 3 ppm, from 0.5 ppm to 1.5 ppm, or from 0.5 ppm to 1.0 ppm. Polyquaternium-1 is present in the lens care solution from 0.5 ppm to 15 ppm, from 1 ppm to 8 ppm or from 1 ppm to 3 ppm. Polyquaternium-42, often referred to as polixetonium, is present in the solutions from 5 ppm to 60 ppm. Alexidine is present in the solutions from 0.5 ppm to 5 ppm or from 0.5 ppm to 2 ppm.

It is to be understood by those in the art that the compositions can include one or more of the antimicrobial components described above. For example, in one embodiment, the ophthalmic compositions include polyquaternium-1 in combination with PHMB. With such combination of antimicrobial components the polyquaternium-1 is present in relatively low concentrations, that is, from 0.5 ppm to 3 ppm, relative to the reported concentration of polyquaternium-1 in both Opti-Free®Express and Opti-Free®Replenish. Applicants believe that the polyquaternium-1 and the PHMB, in combination, can enhance the biocidal efficacy of a lens care solution. Another, preferred composition will comprise from 0.6 ppm to 1.2 ppm PHMB and from 1 ppm to 6 ppm polyquaternium-42.

The lens care solutions will likely comprise effective amounts of one or more known lens care formulation components such as a detergent or surfactant component, a comfort component, a chelating or sequestering component, a buffer or a tonicity component.

Suitable surfactants can be either amphoteric or nonionic, and are typically present (individually or in combination) in amounts up to about 5% (w/v). The surfactant should be soluble in the lens care solution and non-irritating to ocular tissues. The presence of nonionic surfactants comprising one or more chains or polymeric components having oxyalkylene (—O—R—) repeats units wherein R has 2 to 6 carbon atoms are common to lens care solutions. Satisfactory non-ionic surfactants include polyethylene glycol esters of fatty acids, e.g. coconut, polysorbate, polyoxyethylene or polyoxypropylene ethers of higher alkanes (C₁₂-C₁₈). Examples of this class include polysorbate 20 (available under the trademark Tween® 20), polyoxyethylene (23) lauryl ether (Brij® 35), polyoxyethyene (40) stearate (Myrj®52), polyoxyethylene (25) propylene glycol stearate (Atlas® G 2612). Still other preferred surfactants include tyloxapol, polysulfates, polyethylene glycol, alkyl esters and any mixture thereof. The surfactants will generally be present in a total amount from 0.1 to 2.0% w/v, from 0.1 to 1.0% w/v, or from 0.2 to 0.8% w/v.

A particular nonionic surfactant consisting of a poly(oxypropylene)-poly(oxyethylene) adduct of ethylene diamine having a molecular weight from about 7,500 to about 27,000 wherein at least 40 weight percent of said adduct is poly(oxyethylene) has been found to be particularly advantageous for use in cleaning and conditioning both soft and hard contact lenses when used in amounts from about 0.05 to about 2.0 wt. %. The CTFA Cosmetic Ingredient Dictionary's adopted name for this group of surfactants is poloxamine. Such surfactants are available from BASF Wyandotte Corp., Wyandotte, Mich., under Tetronic®.

An analogous of series of surfactants, for use in the lens care compositions, is the poloxamer series which is a poly(oxyethylene) poly(oxypropylene) block polymers available under Pluronic® (commercially available form BASF). In accordance with one embodiment of a lens care composition the poly(oxyethylene)-poly(oxypropylene) block copolymers will have molecular weights from 2500 to 13,000 daltons or from 6000 to about 12,000 daltons. Specific examples of surfactants which are satisfactory include: poloxamer 108, poloxamer 188, poloxamer 237, poloxamer 238, poloxamer 288 and poloxamer 407. Particularly good results are obtained with poloxamer 237. The poly(oxyethylene) poly(oxypropylene) block polymer surfactants will generally be present in a total amount from 0.1 to 2.0% w/v, from 0.1 to 1.0% w/v, or from 0.2 to 0.8% w/v.

The amphoteric surfactants of general formula I are surface-active compounds with both acidic and alkaline properties. The amphoteric surfactants of general formula I include a class of compounds known as betaines. The betaines are characterized by a fully quaternized nitrogen atom and do not exhibit anionic properties in alkaline solutions, which means that betaines are present only as zwitterions at near neutral pH. An amphoteric surfactant of general formula I

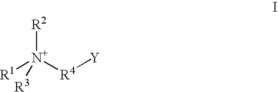

wherein R¹ is R or —(CH₂)ₙ—NHC(O)R, wherein R is a C₈-C₃₀alkyl optionally substituted with hydroxyl and n is 2, 3 or 4; R² and R³ are each independently selected from the group consisting of hydrogen and C₁-C₄alkyl; R⁴ is a C₂-C₈alkylene optionally substituted with hydroxyl; and Y is CO₂⁻ or SO₃⁻, can be present in the ophthalmic compositions, typically from 0.01 wt. % to 2 wt. %.

All betaines are characterized by a fully quaternized nitrogen. In alkyl betaines, one of the alkyl groups of the quaternized nitrogen is an alkyl chain with eight to thirty carbon atoms. One class of betaines is the sulfobetaines or hydroxysulfobetaines in which the carboxylic group of alkyl betaine is replaced by sulfonate. In hydroxysulfobetaines a hydroxy-group is positioned on one of the alkylene carbons that extend from the quaternized nitrogen to the sulfonate. In alkylamido betaines, an amide group is inserted as a link between the hydrophobic C₈-C₃₀alkyl chain and the quaternized nitrogen.

In many embodiments, the amphoteric surfactant of general formula I is a sulfobetaine of general formula II

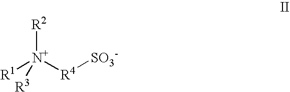

wherein R¹ is a C₈-C₃₀alkyl; R² and R³ are each independently selected from a C₁-C₄alkyl; and R⁴ is a C₂-C₈alkylene.

Certain sulfobetaines of general formula II are more preferred than others. For example, Zwitergent®3-10 available from Calbiochem Company, is a sulfobetaine of general formula I wherein R¹ is a straight, saturated alkyl with ten (10) carbons, R² and R³ are each methyl and R⁴ is —CH₂CH₂CH₂— (three carbons, (3)). Other sulfobetaines that can be used in the ophthalmic compositions include the corresponding Zwitergent®3-08 (R¹ is a is a straight, saturated alkyl with eight carbons), Zwitergent®3-12 (R¹ is a is a straight, saturated alkyl with twelve carbons), Zwitergent®3-14 (R¹ is a is a straight, saturated alkyl with fourteen carbons) and Zwitergent®3-16 (R¹ is a is a straight, saturated alkyl with sixteen carbons). Accordingly, some of the more preferred the ophthalmic composition will include a sulfobetaine of general formula II wherein R¹ is a C₈-C₁₆alkyl and R² and R³ is methyl.

In another embodiment, the amphoteric surfactant of general formula I is a hydroxysulfobetaine of general formula III

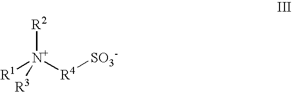

wherein R¹ is a C₈-C₃₀alkyl substituted with at least one hydroxyl; R² and R³ are each independently selected from a C₁-C₄alkyl; and R⁴ is a C₂-C₈alkylene substituted with at least one hydroxyl.

In another embodiment, the amphoteric surfactant is an alkylamido betaine of general formula IV

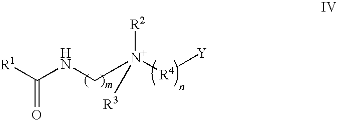

wherein R¹ is a C₈-C₃₀alkyl, and m and n are independently selected from 2, 3, 4 or 5; R² and R³ are each independently selected from a C₁-C₄alkyl optionally substituted with hydroxyl; R⁴ is a C₂-C₈alkylene optionally substituted with hydroxyl; and Y is CO₂″ or SO₃″. The most common alkylamido betaines are alkylamidopropyl betaines, e.g., cocoamidopropyl dimethyl betaine and lauroyl amidopropyl dimethyl betaine.

The lens care solutions can also include a phosphonic acid, or its physiologically compatible salt, that is represented by the following formula:

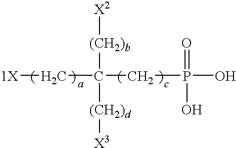

wherein each of a, b, c, and d are independently selected from integers from 0 to 4, preferably 0 or 1; X¹ is a phosphonic acid group (i.e., P(OH)₂O), hydroxy, amine or hydrogen; and X² and X³ are independently selected from the group consisting of halogen, hydroxy, amine, carboxy, alkylcarbonyl, alkoxycarbonyl, or substituted or unsubstituted phenyl, and methyl. Exemplary substituents on the phenyl are halogen, hydroxy, amine, carboxy and/or alkyl groups. A particularly preferred species is that wherein a, b, c, and d in are zero, specifically the tetrasodium salt of 1-hydroxyethylidene-1,1-diphosphonic acid, also referred to as tetrasodium etidronate, commercially available from Monsanto Company as DeQuest® 2016 diphosphonic acid sodium salt or phosphonate.

The lens care solutions can also include one or more comfort or cushioning components. The comfort component can enhance and/or prolong the cleaning and wetting activity of the surfactant component and/or condition the lens surface rendering it more hydrophilic (less lipophilic) and/or to act as a demulcent on the eye. The comfort component is believed to cushion the impact on the eye surface during placement of the lens and serves also to alleviate eye irritation. Suitable comfort components include, but are not limited to, water soluble natural gums, cellulose-derived polymers and the like. Useful natural gums include guar gum, gum tragacanth and their derivatives such as hydroxypropyl guar. Useful cellulose-derived comfort components include cellulose-derived polymers, such as hydroxypropyl cellulose, hydroxypropylmethyl cellulose, carboxymethyl cellulose, methyl cellulose, hydroxyethyl cellulose and the like. A very useful comfort component is hydroxypropylmethyl cellulose (HPMC). Some non-cellulose comfort components include propylene glycol or glycerin. The comfort components are typically present in the solution from 0.01% to 1% (w/v).

One comfort agent has been shown to provide exceptional comfort to contact lens patients. Hyaluronic acid can be isolated from a variety of natural sources and is commercially available from various commercial suppliers. In its natural form, hyaluronic acid has a molecular weight in the range of 5×10⁴ up to 1×10⁷ daltons. Its molecular weight may be reduced via a number of cutting processes such as exposure to acid, heat (e.g., autoclave, microwave, dry heat) or ultrasound.

Hyaluronic acid can be isolated from rooster combs, relatively costly process. See, U.S. Pat. Nos. 4,141,973; 4,784,990; 5,099,013; 5,166,331; 5,316,926; 5,411,874; 5,559,104 and 5,925,626. Alternatively, hyaluronic acid can be prepared by fermentation of bacteria such as streptococci. The bacteria are incubated in a sugar rich broth, and the produced hyaluronic acid is separated from impurities and purified. The molecular weight of hyaluronic acid produced via fermentation can be set by the sugars placed in the fermentation broth. Hyaluronic acid produced by extraction and fermentation is commercially available.

The hyaluronic acid produced by fermentation can have several commercial advantages over hyaluronic acid produced from extraction and purification of natural sources. Hyaluronic acid obtained from a fermentation mixture comprising Streptococcus equi is particularly advantageous. Also, it is advantageous that the hyaluronic acid have a glucuronic acid content that is greater than 42% by weight.

The lens care solutions can also include dexpanthenol, which is an alcohol of pantothenic acid, also called Provitamin B5, D-pantothenyl alcohol or D-panthenol. In some formulations of the lens care compositions, dexpanthenol can exhibit good cleansing action and can stabilize the lachrymal film at the eye surface when placing a contact lens on the eye. Dexpanthenol is present in the lens care solutions from 0.2% to 10% (w/v), from 0.5% to 5% (w/v), or from 1% to 3% (w/v).

The lens care solutions can also include sorbitol, which is a hexavalent sugar alcohol. Typically, dexpanthenol is used in combination with sorbitol. In specific formulations the combination dexpanthenol and sorbitol can provide enhanced cleansing action and can also stabilize the lachrymal film following placement of the contact lens on the eye. These formulations can substantially improve patient comfort when wearing contact lenses. Sorbitol is present in the lens care compositions in an amount from 0.4% to 10% (w/v), from 0.8% to 6% (w/v) or from 1% to 3% (w/v).

The lens care solutions can also include one or more neutral or basic amino acids. The neutral amino acids include: the alkyl-group-containing amino acids such as alanine, glycine, isoleucine, valine, leucine and proline; hydroxyl-group-containing amino acids such as serine, threonine and 4-hydroxyproline; thio-group-containing amino acids such as cysteine, methionine and asparagine. Examples of the basic amino acid include lysine, histidine and arginine. The one or more neutral or basic amino acids are present in the compositions at a total concentration of from 0.1% to 5% (w/v).

The lens care solutions can also include glycolic acid, asparatic acid or any mixture of the two at a total concentration of from 0.001% to 4% (w/v) or from 0.01% to 2.0% (w/v). In addition, the combined use of one or more amino acids and glycolic acid and/or asparatic acid can lead to a reduction in the change of the size of the contact lens due to swelling and shrinkage following placement of the lens on the eye. The stated combination provides a higher degree of compatibility with the contact lens compared to the absence of one of the two components in the composition.

The lens care solutions can also include glycolic acid, asparatic acid or any mixture of the two, in combination with 2-amino-2-methyl-1,3-propanediol or a salt thereof. Typically, the molar ratio of the two components glycolic acid and/or asparatic acid to AMPD is 1:20 to 1.3:1.

The contact lens care solutions will likely include a buffer system. By the terms “buffer” or “buffer system” is meant a compound that, usually in combination with at least one other compound, provides a buffering system in solution that exhibits buffering capacity, that is, the capacity to neutralize, within limits, either acids or bases (alkali) with relatively little or no change in the original pH. Generally, the buffering components are present from 0.05% to 2.5% (w/v) or from 0.1% to 1.5% (w/v).

The term “buffering capacity” is defined to mean the millimoles (mM) of strong acid or base (or respectively, hydrogen or hydroxide ions) required to change the pH by one unit when added to one liter (a standard unit) of the buffer solution. The buffer capacity will depend on the type and concentration of the buffer components. The buffer capacity is measured from a starting pH of 6 to 8, preferably from 7.4 to 8.4.

Borate buffers include, for example, boric acid and its salts, for example, sodium borate or potassium borate. Borate buffers also include compounds such as potassium tetraborate or potassium metaborate that produce borate acid or its salt in solutions. Borate buffers are known for enhancing the efficacy of certain polymeric biguanides. For example, U.S. Pat. No. 4,758,595 to Ogunbiyi et al. describes that a contact-lens solution containing a polyaminopropyl biguanide (PAPB), also known as PHMB, can exhibit enhanced efficacy if combined with a borate buffer.

A phosphate buffer system preferably includes one or more monobasic phosphates, dibasic phosphates and the like. Particularly useful phosphate buffers are those selected from phosphate salts of alkali and/or alkaline earth metals. Examples of suitable phosphate buffers include one or more of sodium dibasic phosphate (Na₂HPO₄), sodium monobasic phosphate (NaH₂PO₄) and potassium monobasic phosphate (KH₂PO₄). The phosphate buffer components frequently are used in amounts from 0.01% or to 0.5% (w/v), calculated as phosphate ion.

Other known buffer compounds can optionally be added to the lens care compositions, for example, citrates, citric acid, sodium bicarbonate, TRIS, and the like. Other ingredients in the solution, while having other functions, may also affect the buffer capacity. For example, EDTA, often used as a complexing agent, can have a noticeable effect on the buffer capacity of a solution.

A preferred buffer system is based upon boric acid/borate or a combined boric/phosphate buffer system. For example a combined boric/phosphate buffer system can be formulated from a mixture of sodium borate and phosphoric acid, or the combination of sodium borate and the monobasic phosphate. In a combined boric/phosphate buffer system, the solution comprises about 0.05 to 2.5% (w/v) of a phosphoric acid or its salt and 0.1 to 5.0% (w/v) of boric acid or its salt. The phosphate buffer is used (in total) at a concentration of 0.004 to 0.2 M (Molar), preferably 0.04 to 0.1 M. The borate buffer (in total) is used at a concentration of 0.02 to 0.8 M, preferably 0.07 to 0.2 M.

Another particular buffer system is based on diglycine. Diglycine can be used in the composition as the sole buffer system or in combination with another buffer system. The amount of diglycine or salts thereof in the composition is from 0.01 wt. % to 2 wt. %, 0.05 wt. % to 2 wt. %, 0.1 wt. % to 2 wt. % or from 0.1 wt. % to 0.5 wt. %.

The lens care solutions can also include one or more chelating components to assist in the removal of lipid and protein deposits from the lens surface following daily use. Typically, the ophthalmic compositions will include relatively low amounts, e.g., from 0.005% to 0.05% (w/v) of ethylenediaminetetraacetic acid (EDTA) or the corresponding metal salts thereof such as the disodium salt, Na₂EDTA.

One possible alternative to the chelator Na₂EDTA or a possible combination with Na₂EDTA, is a disuccinate of formula IV below or a corresponding salt thereof;

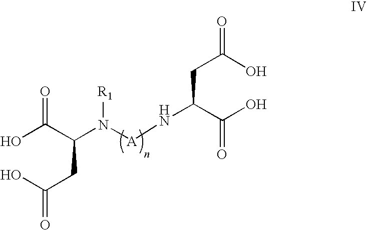

wherein R₁ is selected from hydrogen, alkyl or —C(O)alkyl, the alkyl having one to twelve carbons and optionally one or more oxygen atoms, A is a methylene group or an oxyalkylene group, and n is from 2 to 8. In one embodiment, the disuccinate is S,S-ethylenediamine disuccinate (S,S-EDDS) or a corresponding salt thereof. One commercial source of S,S-EDDS is represented by Octaquest® E30, which is commercially available from Octel. The chemical structure of the trisodium salt of S,S-EDDS is shown below. The salts can also include the alkaline earth metals such as calcium or magnesium. The zinc or silver salt of the disuccinate can also be used in the ophthalmic compositions.

Still another class of chelators include alkyl ethylenediaminetriacetates such as nonayl ethylenediaminetriacetate. See U.S. Pat. No. 6,995,123 for a more complete description of such agents.

The lens care solutions will typically include an effective amount of a tonicity adjusting component. Among the suitable tonicity adjusting components that can be used are those conventionally used in contact lens care products such as various inorganic salts. Sodium chloride and/or potassium chloride and the like are very useful tonicity components. The amount of tonicity adjusting component is effective to provide the desired degree of tonicity to the solution.

The lens care solutions will typically have an osmolality in the range of at least about 200 mOsmol/kg for example, about 300 or about 350 to about 400 mOsmol/kg. The lens care solutions are substantially isotonic or hypertonic (for example, slightly hypertonic) and are ophthalmically acceptable.

One exemplary contact lens solution is prepared with the components and amounts of each listed in Table 1.

TABLE 1

| | | | Preferred |
|---|---|---|---|
| | Minimum | Maximum | Amount |
| Component | Amount (wt. %) | Amount (wt. %) | (wt. %) |
| boric acid | 0.10 | 1.0 | 0.64 |
| sodium borate | 0.01 | 0.20 | 0.1 |
| PEI-2500 or PVP-1800 | 0.001 | 2.0 | 0.1 |
| Zwitergent ® 3-10 | 0.005 | 0.80 | 0.1 |
| hyaluronic acid | 0.005 | 0.05 | 0.01 |
| Tetronic ® 1107 | 0.05 | 2.0 | 1.00 |
| Na₂EDTA | 0.005 | 0.15 | 0.03 |
| PHMB | 0.2 ppm | 2 ppm | 1.3 ppm |
| polyquaternium-1 | 0.5 ppm | 5 ppm | 1 ppm |

Another contact lens care solution includes the components listed in Table 2.

TABLE 2

| | | | Preferred |
|---|---|---|---|
| | Minimum | Maximum | Amount |
| Component | Amount (wt. %) | Amount (wt. %) | (wt. %) |
| propylene glycol | 0.1 | 1.0 | 0.50 |
| poloxamer 237 | 0.01 | 0.20 | 0.05 |
| phosphate monobasic | 0.05 | 0.40 | 0.10 |
| phosphate dibasic | 0.05 | 0.4 | 0.12 |
| PEI-2500 or PVP-1800 | 0.05 | 2.0 | 1.0 |
| hyaluronic acid | 0.005 | 0.02 | 0.008 |
| Na₂EDTA | 0.005 | 0.3 | 0.1 |
| PHMB | 0.2 ppm | 2 ppm | 1.1 ppm |

Another contact lens care solution includes the components listed in Table 3.

TABLE 3

| | | | Preferred |
|---|---|---|---|
| | Minimum | Maximum | Amount |
| Component | Amount (wt. %) | Amount (wt. %) | (wt. %) |
| boric acid | 0.10 | 1.0 | 0.64 |
| sodium citrate | 0.01 | 0.20 | 0.1 |
| PEI-2500 or PVP-1800 | 0.001 | 2.0 | 0.1 |
| hydroxypropyl guar | 0.005 | 0.50 | 0.06 |
| propylene glycol | 0.01 | 0.6 | 0.1 |
| Tetronic ® 1304 | 0.05 | 2.0 | 1.00 |
| nonanyl-EDTA | 0.005 | 0.2 | 0.03 |
| polyquaternium-1 | 2 ppm | 15 ppm | 8 ppm |

Another contact lens care solution includes the components listed in Table 4.

TABLE 4

| | | | Preferred |
|---|---|---|---|
| | Minimum | Maximum | Amount |
| Component | Amount (wt. %) | Amount (wt. %) | (wt. %) |
| poloxamer 407 | 0.01 | 0.20 | 0.05 |
| phosphate monobasic | 0.05 | 0.40 | 0.10 |
| phosphate dibasic | 0.05 | 0.4 | 0.12 |
| DeQuest ® 2016 | 0.05 | 1.0 | 0.5 |
| PEI-2500 or PVP-1800 | 0.05 | 2.0 | 1.0 |
| sodium chlorite | 0.005 | 0.1 | 0.08 |
| peroxide | 10 ppm | 1000 ppm | 150 ppm |
| polyquaternium-42 | 5 | 60 | 15 ppm |

As described, the lens care solutions can be used to clean and disinfect contact lenses. In general, the contact lens solutions can be used as a daily or every other day care regimen known in the art as a “no-rub” regimen. This procedure includes removing the contact lens from the eye, rinsing both sides of the lens with a few milliliters of solution and placing the lens in a lens storage case. The lens is then immersed in fresh solution for at least two hours. The lens is the removed form the case, optionally rinsed with more solution, and repositioned on the eye.

Alternatively, a rub protocol would include each of the above steps plus the step of adding a few drops of the solution to each side of the lens, followed by gently rubbing the surface between ones fingers for approximately 3 to 10 seconds. The lens can then be, optionally rinsed, and subsequently immersed in the solution for at least two hours. The lenses are removed from the lens storage case and repositioned on the eye.

The lens care solutions can be used with many different types of contact lenses including: (1) hard lenses formed from materials prepared by polymerization of acrylic esters, such as poly(methyl methacrylate) (PMMA), (2) rigid gas permeable (RGP) lenses formed from silicone acrylates and fluorosilicone methacrylates, (3) soft, hydrogel lenses, and (4) non-hydrogel elastomer lenses.

As an example, soft hydrogel contact lenses are made of a hydrogel polymeric material, a hydrogel being defined as a crosslinked polymeric system containing water in an equilibrium state. In general, hydrogels exhibit excellent biocompatibility properties, i.e., the property of being biologically or biochemically compatible by not producing a toxic, injurious or immunological response in a living tissue. Representative conventional hydrogel contact lens materials are made by polymerizing a monomer mixture comprising at least one hydrophilic monomer, such as (meth)acrylic acid, 2-hydroxyethyl methacrylate (HEMA), glyceryl methacrylate, N,N-dimethacrylamide, and N-vinylpyrrolidone (NVP). In the case of silicone hydrogels, the monomer mixture from which the copolymer is prepared further includes a silicone-containing monomer, in addition to the hydrophilic monomer. Generally, the monomer mixture will also include a crosslink monomer such as ethylene glycol dimethacrylate, tetraethylene glycol dimethacrylate, and methacryloxyethyl vinylcarbonate. Alternatively, either the silicone-containing monomer or the hydrophilic monomer may function as a crosslink agent.

The lens care solutions can also be formulated as a contact lens rewetting eye drop solution. By way of example, the rewetting drops can be formulated in accordance to any one of the formulations of Tables 1 to 4. For example, the formulations can be modified by increasing the amount of surfactant, by reducing the amount of antimicrobial agent to a preservative amount and/or by increasing the concentration of the listed comfort agent.

### Example 1

### PHMB/BBS Solution with 2 wt. % PVP

One liter of borate buffered saline (pH=7.2) was prepared as the base solution. Ten parts per million (ppm) of PHMB was also prepared to investigate the PHMB uptake by PureVision® contact lenses with and without 2 wt. % poly(vinylpyrrolidone) (PVP-1800, Mₙ=1800). The non-control experiments (with lenses) were performed with ten contact lenses that soaked in the solutions overnight. The relative uptake of PHMB in the contact lenses with and without PVP-1800 is listed in Table 5.

TABLE 5

| | | | relative |
|---|---|---|---|
| | | PHMB Concentrations in | PHMB |
| | # of Contact | the Solution Detected | uptake |
| Solutions | Lenses | after soaked overnight | by lenses |
| 10 ml PBS with | 0 (control) | 8.0 ppm | — |
| 10 ppm PHMB | | | |
| 10 ml PBS with | 10 (Comp. Ex.) | 0.60 ppm | 92.5% |
| 10 ppm PHMB | | | |
| 10 ml PBS with | 0 (control) | 7.9 ppm | — |
| 10 ppm PHMB | | | |
| and 2% PVP | | | |
| 10 ml PBS with | 10 | 1.2 ppm | 84.8% |
| 10 ppm PHMB | | | |
| and 2% PVP | | | |

### Preparation of PVP-1800

The procedure was modeled after a synthesis which used the RAFT reagent ethyl-α-(O-ethylxanthyl)propionate. An oven dried round bottom reaction flask fitted with a septum, magnetic stirrer and a thermo controller. The flask was charged with NVP, (50 ml) anhydrous 1-4 dioxane (50 ml), RAFT reagent (6.45 g, 0.029 moles) and azobisisobutrylnitrile (AIBN) (0.003 moles). Dry nitrogen was bubbled through the reaction mixture for 30 minutes to remove dissolved oxygen. The vessel was then heated at 60° C. under a passive blanket of nitrogen overnight. The polyvinylpyrrolidinone with a RAFT end group was isolated by precipitation into a large volume (3 L) of ethyl ether. The isolated yield of polymer was 47.1 grams (80%). The polymer was characterized by MALDI mass spectrometry and had a Mₙ=1797, M_{w}=1901 and a polydispersity of 1.1.

### Example 2

### PHMB/BBS Solution with 0.1 wt. % PEI-1800

One liter of borate buffered saline (pH=7.2) was prepared as the base solution. Ten parts per million (ppm) of PHMB was also prepared to investigate the PHMB uptake by PureVision® contact lenses with and without 0.1% of poly(ethyleneimine) (PEI), molecular weight 1800 daltons (available as Cat # 06089 from Polysciences, Inc., Warrington, Pa.). The non-control experiments (with lenses) were performed with three contact lenses that soaked in the solutions overnight. The relative uptake of PHMB in the contact lenses with and without PEI-1800 is listed in Table 6. The PHMB uptake by PureVision contact lenses decreases approximately 20% when 0.1% poly(ethyleneimine) was present in the solution compared to no PEI in the solution.

TABLE 6

| | # of | | relative PHMB |
|---|---|---|---|
| | contact | PHMB conc. after | uptake |
| Solutions | lenses | soaking overnight | by lenses |
| 10 ml BBS with | 0 (control) | 10.13 ppm | — |
| 10 ppm PHMB | | | |
| 10 ml BBS with | 3 (comp.) | 3.26 ppm | 67.9% |
| 10 ppm PHMB | | | |
| 10 ml BBS with 10 ppm | 0 (control) | 10.61 ppm | — |
| PHMB and 0.1% PEI | | | |
| 10 ml BBS with 10 ppm | 3 | 5.46 ppm | 48.5% |
| PHMB and 0.1% PEI | | | |

### Example 3

### PHMB/BBS Solution with 0.1 wt. % PEI-2500

One liter of borate buffered saline (pH=7.2) was prepared as the base solution. Ten parts per million (ppm) of PHMB was also prepared to investigate the PHMB uptake by PureVision® contact lenses with and without 0.1% of poly(ethyleneimine) (PEI), molecular weight 2500 daltons (available as Cat # 24313 from Polysciences, Inc., Warrington, Pa.). The non-control experiments (with lenses) were performed with three contact lenses that soaked in the solutions overnight. The PHMB uptake by PureVision contact lenses decreases approximately 20% when 0.1% poly(ethyleneimine) was present in the solution compared to no PEI in the solution. The relative uptake of PHMB in the contact lenses with and without PEI-2500 is listed in Table 7. The PHMB uptake by PureVision contact lenses decreases approximately 52% when 0.1% poly(ethyleneimine) (Mw=2500 daltons) was present in the solution compared to no PEI in the solution.

TABLE 7

| | # of | PHMB conc. | |
|---|---|---|---|
| | contact | after soaking | relative PHMB |
| Solutions | lenses | overnight | uptake by lenses |
| 10 ml BBS with | 0 (control) | 10.13 ppm | — |
| 10 ppm PHMB | | | |
| 10 ml BBS with | 3 (comp.) | 3.26 ppm | 67.9% |
| 0 ppm PHMB | | | |
| 10 ml BBS with 10 ppm | 0 (control) | 10.04 ppm | — |
| PHMB and 0.1% linear PEI | | | |
| 10 ml BBS with 10 ppm | 3 | 8.41 ppm | 16.2% |
| PHMB and 0.1% linear PEI | | | |

### Example 4

### Polyquaternium-1/BBS Solution with 0.1 wt. % PEI-2500

One liter of borate buffered saline (pH=7.2) is prepared as the base solution. Ten parts per million (ppm) of polyquaternium-1 is also prepared to investigate the uptake of polyquaternium-1 by PureVision® contact lenses with and without 0.1% of poly(ethyleneimine) (PEI), molecular weight 2500 daltons (available as Cat # 24313 from Polysciences, Inc., Warrington, Pa.). The non-control experiments (with lenses) are performed with three contact lenses that soak in the solutions overnight. The uptake of polyquaternium-1 by PureVision contact lenses decreases approximately 10% to 40% if 0.1% PEI is present in the solution compared to no PEI in the solution.

We claim:

1. A contact lens care solution comprising:
a cationic antimicrobial component having an average molecular weight (M_{NA}); and
a cationic oligomer or nitrogen/amine oligomer having a number average molecular weight (M_{NO}) from 500 daltons to 15,000 daltons, wherein the wherein the cationic oligomer or nitrogen/amine oligomer is present in the composition from 0.01 wt. % to 1.0 wt. %, and the composition comprises a ratio M_{NO}:M_{NA} from 5:1 to 1:5.

2. The lens care solution of claim 1, wherein the ratio M_{NO}:M_{NA} is from 3:1 to 1:3.

3. The lens care solution of claim 1, wherein the cationic antimicrobial component is poly(hexamethylene biguanide), which is present in the composition from 0.3 ppm to 2 ppm, or polyquaternium-1, which is present in the composition from 0.5 ppm to 15 ppm.

4. The lens care solution of claim 1, further comprising a comfort agent selected from the group consisting of dexpanthenol, hydroxypropyl guar, hyaluronic acid, hydroxypropylmethyl cellulose and the corresponding metal salts of each thereof.

5. The lens care solution of claim 4, wherein the comfort agent is hyaluronic acid.

6. The lens care solution of claim 1, wherein the cationic oligomer or nitrogen/amine oligomer is selected from the group consisting of polyvinylpyridine, polyvinylpyrrolidone, polyethyleneimine and a copolymer comprising polyvinylpyridine, polyvinylpyrrolidone or polyethyleneimine.

7. The lens care solution of claim 1, wherein the number average molecular weight of the cationic oligomer or nitrogen/amine oligomer is from 1500 daltons to 6000 daltons.

8. The lens care solution of claim 6, wherein the number average molecular weight of the cationic oligomer or nitrogen/amine oligomer is from 1500 daltons to 6000 daltons.

9. The lens care solution of claim 6, wherein the cationic antimicrobial component is poly(hexamethylene biguanide) and is present in the solution from 0.1 ppm to 2.0 ppm, and the hyaluronic acid and is present in the composition from 0.005 wt. % to 0.04 wt. %.

10. A method of cleaning and disinfecting a contact lens, the method comprising instructing a person who uses contact lenses to soak the contact lens in the composition of claim 1 for at least 2 hours.

11. The method of claim 10, further comprising instructing the person to place the soaked contact lens on the eye without the need to rinse the soaked lens prior to placement on the eye.

12. A contact lens care solution comprising:
a cationic antimicrobial component having an average molecular weight (M_{NA}); and
0.01 wt. % to 1.0 wt. % polyvinylpyrrolidone oligomer having a number average molecular weight (M_{NO}) from 500 daltons to 5,000 daltons, and the composition comprises a ratio M_{NO}:M_{NA} from 5:1 to 1:5.

13. The lens care solution of claim 12, wherein the ratio M_{NO}:M_{NA} is from 3:1 to 1:3.

14. The lens care solution of claim 12, wherein the cationic antimicrobial component is poly(hexamethylene biguanide), which is present in the composition from 0.3 ppm to 2 ppm, polyquaternium-1, which is present in the composition from 0.5 ppm to 15 ppm, or polyquaternium-42, which is present in the composition from 5 ppm to 60 ppm.
